(19) United States
(12) Patent Application Publication
(10) Pub. No.: US 2008/0266697 A1
(43) Pub. Date: Oct. 30, 2008

(54) INFORMATION RECORDING DEVICE, RECORDING DEVICE MANAGEMENT SYSTEM AND INFORMATION RECORDING DEVICE MANAGEMENT METHOD

(75) Inventors: Mitsuhiko Ohta, Kawasaki (JP); Atsuo Ilda, Kawasaki (JP); Hitoshi Komoriya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/060,550

(22) Filed: Apr. 1, 2008

(30) Foreign Application Priority Data
Apr. 27, 2007 (JP) 2007-119923

(51) Int. Cl. G11B 5/02

(52) U.S. Cl. 360/57

(57) ABSTRACT

The present invention relates to an information recording device that writes data onto a recording medium having a recording density based on the number of write/erase cycles reasonably guaranteed to not produce errors in adjacent tracks. The recording medium includes a first storage region where the number of data write/erase cycles are restricted; and a second storage region where the number of data write/erase cycles are not restricted.

### BACKGROUND OF THE INVENTION

1. Field of the Invention

This invention relates to an information recording device that writes data onto a recording medium having a recording density based on guaranteed write/erase cycles and specifically, relates to an information recording device, a recording device management system and a recording device management method that enables to increased a storage capacity of a recording medium without deteriorating access performance to data stored thereon.

2. Description of the Related Art

Conventionally, a magnetic disk device (hereinafter referred to as HDD) has been in use as a recording device for computer systems and a variety of electric devices. There is demand to increase a storage capacity of the HDD. Thus, the HDD has been typically developed and designed on the basis that its recording capacity will be increased.

To increase the recording capacity of the HDD, the recording density on a magnetic disk (the recording medium) should be increased. For that purpose, there have been the methods for increasing a track density in a radius direction of the magnetic disk (TPI: track per inch), or increasing a density in a track direction, i.e., in a bit direction (BPI: bit per inch) (E.g., Japanese Unexamined Patent Application Publication No. 2002-237142).

However, the higher the track density on the magnetic disk is, the narrower intervals between adjoining tracks become. Consequently, where the data is written/erased onto or from a track which is focused by a recording head, interference with adjacent tracks can occur. In the worst case, a problem such that the data having been written onto the adjacent tracks could be rewritten or erased partially or completely may arise.

Thus, there has been an attempt to reduce the interference in the adjacent tracks in order to increase the recording density of the magnetic disk and the recording capacity of the HDD by restricting the write/erase cycles of data onto the same region on the magnetic disk.

However, when the storage capacity of the HDD is increased by restricting the number of rewritings of data, where data with no restraint upon the write/erase cycles (e.g., a temporary file used for OS—operating system; hereinafter referred to as no-restraint-data) is recorded, a problem in that an access performance of the no-restraint-data is deteriorated has arisen.

For this reason, where the HDD records the no-restraint-data onto a region where the write/erase cycles of data is restricted (hereinafter referred to as restricted region), the revised no-restraint-data is added to the restricted region in parallel with recording data denoting the revision of the no-restraint-data (hereinafter referred to as revision-marking-data), and the revision-marking-data should be referred every time the no-restraint-data is accessed.

This invention is presented to solve aforementioned problems relating to the conventional technique. That is to say, this invention aims to provide an information recording device, the recording device management system and the recording device management method that can enable increase in the storage capacity of the recording medium without deteriorating the access performance of data stored thereon.

### SUMMARY

In accordance with an aspect of embodiment, an information recording device for data writing onto a recording medium having a recording density based on guaranteed write/erase cycles, has a recording medium including a first storage region where the number of data write/erase cycles are restricted; and a second storage region where the number of data write/erase cycles are not restricted.

### BRIEF DESCRIPTION OF THE DRAWINGS

FIG. 1 illustrates a general outline and features of the information recording device in the first embodiment.

FIG. 2 shows an enlarged view of a block of the magnetic disk shown in FIG. 1.

FIG. 3 shows a relationship between an error rate and the guaranteed write/erase cycles with different track pitches.

FIG. 4 shows a relationship between the track pitches and the guaranteed write/erase cycles.

FIG. 5 shows a relationship between the BPI in the bit direction and the guaranteed write/erase cycles.

FIG. 6 shows a functional block diagram illustrating a structure of a servo track writer.

FIG. 7 shows one of examples showing a data structure of a track pitch management table.

FIG. 8 shows one of examples illustrating a structure of initialization setting data.

FIG. 9 shows a functional block diagram illustrating a structure of the information recording device in the first embodiment.

FIG. 10 shows one of examples showing a data structure of a zone management table.

FIG. 11 shows one of examples showing a data structure of a data type management table.

FIG. 12 shows a flow chart illustrating procedures of the information recording device in the first embodiment.

FIG. 13 shows a block diagram illustrating a structure of the information recording system in the second embodiment.

FIG. 14 shows an example of a data structure of a HDD management table.

FIG. 15 shows a flow chart illustrating procedures of the information recording system in the second embodiment.

FIG. 16 shows an example of a magnetic disk having zones N, M and L.

FIG. 17 shows setting example (1) illustrating zones set for different recording densities.

FIG. 18 shows setting example (2) illustrating zones set for different recording densities.

### DETAILED DESCRIPTION OF THE EMBODIMENTS

Referring to the drawings attached, the best modes of the information recording device, the recording device management system and the recording device management method in this invention will be discussed below.

### The First Embodiment

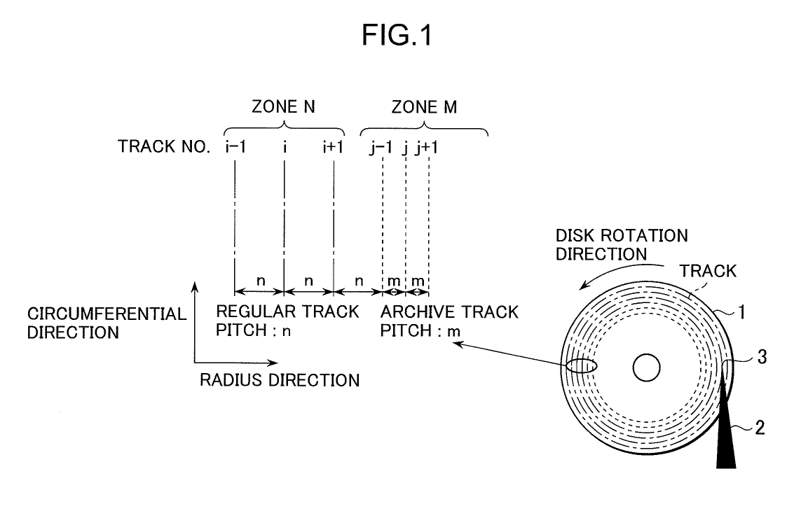

Firstly, an overview and the features of the information recording device in the first embodiment will be described. FIG. 1 illustrates the outline and the features of the information recording device in the first embodiment. As per FIG. 1, the information recording device in the first embodiment loads magnetic disk 1 having zones having different recording densities (zones N and M) and records data with head 3 attached to the end of arm 2.

Zone N is a region where data with no restraint upon the write/erase cycles (such as the temporary file used for OS, hereinafter referred to as no-restraint-data) is stored. The track pitch of zone N is defined as n. For example, the track pitch between track No. i−1 (i is an integral number) and track No. i is defined as 0.3 μm (a track pitch of zone N is hereinafter referred to as a regular track pitch). Generally, the regular track pitch is in a certain degree of size that can circumvent the interference in the adjoining tracks in data writing/erasing. Thus, the no-restraint-data can be recorded onto zone N repeatedly.

Zone N has no restraint upon the write/erase cycles, which eliminates the need for storing the revision-marking-data, and further, referring to the revision-marking-data in accessing the data recorded onto zone N, avoids deterioration of the access performance of the no-restraint-data recorded onto zone N.

By contrast, zone M is a region where data has restrictions upon the write/erase cycles (such as user data; hereinafter referred to as restraint-data). The track pitch of zone M is defined as m in this embodiment. E.g., the track pitch between track No. j−1 ( is an integral number) and track No. j is defined as 0.15 μm (a track pitch of zone M is hereinafter referred to as an archive track pitch). Since the archive track pitch is narrower, the recording density of zone M can be increased, thereby increasing the recording capacity of magnetic disk 1, avoiding recording data onto the same region many times. Therefore, adjacent tracks of zone M are insusceptible to the interference in data recording. The track pitch between zones N and M is defined as n.

The information recording device in the first embodiment judges whether data to be written is the restraint-data or not and writes the data onto zone N or zone M based on the judgment. For convenience sake, only zones N and M are described here, however, other regions different from zone N and M in recording densities can be set on magnetic disk 1.

As described above, the information recording device in the first embodiment loads magnetic disk 1 having the regions having different recording densities, writing onto zone N or zone M according to the data's characteristics. Thus the recording capacity of magnetic disk 1 can be increased without deteriorating the access performance of the data recorded thereon.

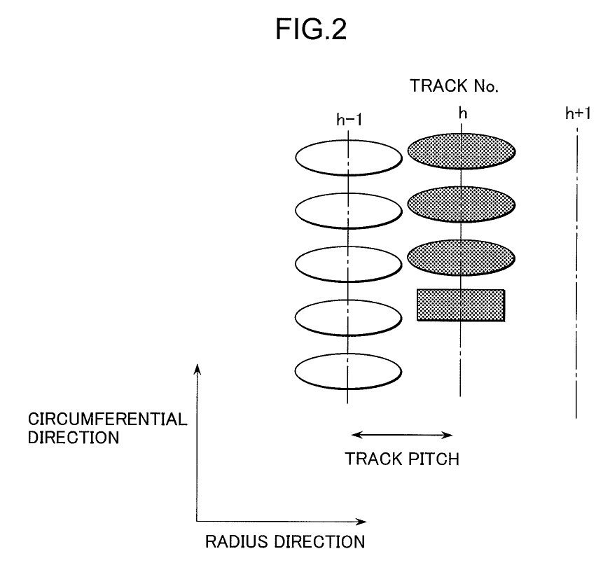

Next, magnetic disk 1 shown in FIG. 1 will be described. FIG. 2 shows the enlarged view of magnetic disk 1 shown in FIG. 1. Where the enlarged portion shown in FIG. 2 is included in zone N, the track pitch of zone N will be the regular track pitch. Where the enlarged portion shown in FIG. 2 is included in zone M, the track pitch of zone M will be the archive track pitch.

To increase the recording density of magnetic disk 1, there are two methods: one is to increase the track density (TPI: track per inch) in the radius direction and the other is to increase the track density (BPI: bit per inch) in the circumferential direction (i.e., the bit direction).

Head 3 to record data onto magnetic disk 1 has a certain width, and thus a pattern written onto magnetic disk 1 has a certain width (track width). Therefore, where recording data onto the adjacent track No. h after recording data onto track No. h−1 (h is an integral number), a problem that the data recorded onto track No. h−1 is rewritten or erased occurs. This occurs more frequently when the track pitch is narrow.

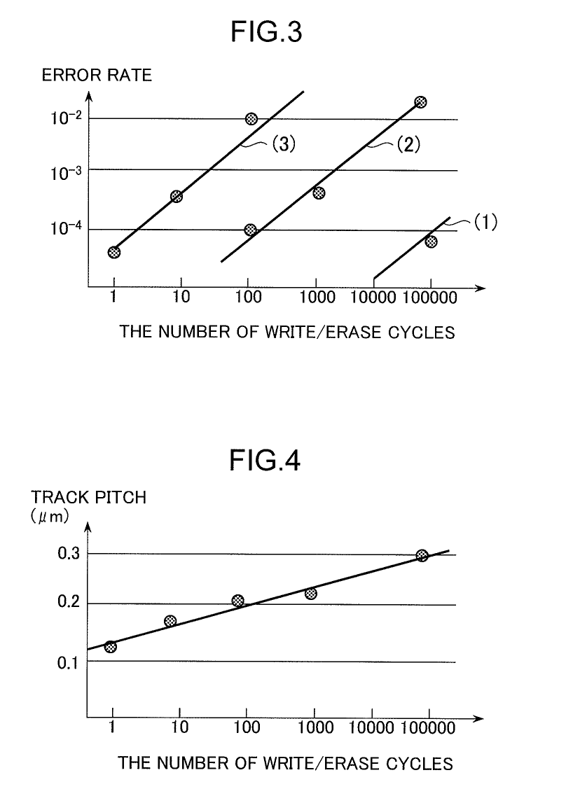

FIG. 3 shows the relationship between the error rate and the write/erase cycles guaranteed with different track pitches. The write/erase cycles guaranteed referred to here means the data write/erase cycles guaranteed onto the same region of magnetic disk 1 in FIG. 1.

In FIG. 3, the transverse axis shows the write/erase cycles guaranteed to track No. h logarithmically and the transverse axis shows the deterioration of signal recorded onto track No. h−1 in error rate (arbitrary unit). FIG. 3 [1] shows the relationship between the error rate and the write/erase cycles guaranteed where the track pitch is 0.3 μm. FIG. 3 [2] shows the relationship between the error rate and the write/erase cycles guaranteed where the track pitch is 0.2 μm. FIG. 3 [3] shows the relationship between the error rate and the guaranteed write/erase cycles where the track pitch is 0.15 μm. For instance, the maximum acceptable error rate shall be less than 10⁻⁴ (viz, the error rate should be lower than 1/10000).

As per FIG. 3, where setting the write/erase cycles guaranteed to 100,000 or greater, the track pitch cannot be set to less than 0.3 μm. Contrarily, where setting the write/erase cycles guaranteed to on the order of 100, the track pitch (the archive track pitch) can be set to 0.2 μm (refer to FIG. 3 [2]).

In other words, where the write/erase cycles guaranteed is set to on the order of 100, the recording density of magnetic disk 1 in the radius direction can be increased to approximately 1.5 times, thereby increasing the storage capacity of entire magnetic disk 1. Likewise, where the write/erase cycles guaranteed is restricted to 1, the track pitch (the archive track pitch) can be set to 0.15 μm. Thus the storage capacity of magnetic disk 1 can be increased further (refer to FIG. 3 [3]).

FIG. 4 shows the relationship between the track pitch and the write/erase cycles guaranteed. In FIG. 4, the transverse axis shows track pitches (μm) and the transverse axis shows the write/erase cycles guaranteed logarithmically. As per FIG. 4, the track pitches are virtually proportional to the write/erase cycles guaranteed. That is, the track per inch (TPI) of magnetic disk 1 can be increased by decreasing the write/erase cycles guaranteed. With the information recording device in this embodiment, the recording density can be increased by decreasing the write/erase cycles guaranteed to the region corresponding to zone M.

Here, contributing factors in narrowing the track pitch by decreasing the write/erase cycles guaranteed is described. The leading factor is a reach of a magnetic field radiated from head 3. FIG. 2 shows a magnetization pattern in one recording, where the magnetic field radiated from head 3 spreads further than the magnetization pattern. Therefore, where data is recorded repeatedly, the magnetization pattern will spread as ink spreads, which rewrites or erases the data recorded onto adjoining tracks.

Another factor is deviation of head 3 from an appropriate position. Head 3 is attached to the end of arm 2 (refer to FIG. 1), which is affected by rotary oscillation of a motor to rotate magnetic disk 1 (not illustrated) and an airflow caused by the rotation of magnetic disk 1. Thus the relative position of arm 2 and magnetic disk 1 is deviated. This deviation is caused randomly. Therefore, the possibility of rewriting or erasing data on the adjacent tracks is increased as the write/erase cycles guaranteed increases.

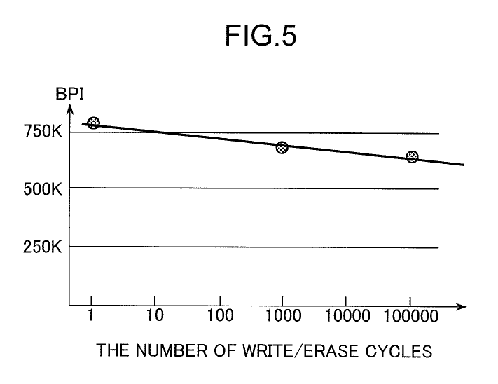

FIG. 5 shows the relationship between the BPI and the write/erase cycles guaranteed. In FIG. 5, the transverse axis shows the BPI and the transverse axis shows the write/erase cycles guaranteed. As per FIG. 5, the write/erase cycles guaranteed increase with the BPI increase.

Here, contributing factors in increasing the BPI by decreasing the write/erase cycles will be described. For magnetic recording, a previously recorded pattern resides slightly when data is rewritten onto the same track. Generally, as the BPI increases, the magnetic field in data writing is narrowed, which makes the remnant of the previously recorded pattern more noticeable. Therefore, the BPI has been tended to be decreased.

The information recording device in this embodiment can increase the BPI by decreasing the write/erase cycles to the region corresponding to zone M. As per FIG. 5, the increase of the BPI attributable to by decreasing the write/erase cycles becomes 20% of the increase of the BPI.

Then a device to initialize magnetic disk 1 shown in FIG. 1 will be described. The device to initialize magnetic disk 1 can be actuated by various devices. In this embodiment, a servo track writer (STW) will be described as an example. The STW is a device to record servo data onto magnetic disk 1. The information recording device reads the servo data recorded onto magnetic disk 1 and positions head 3.

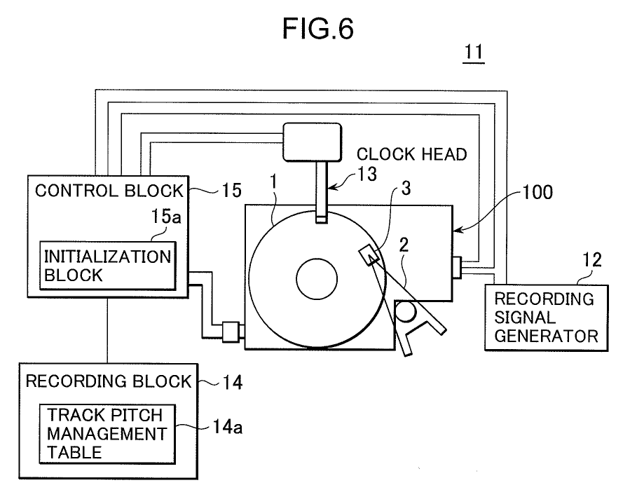

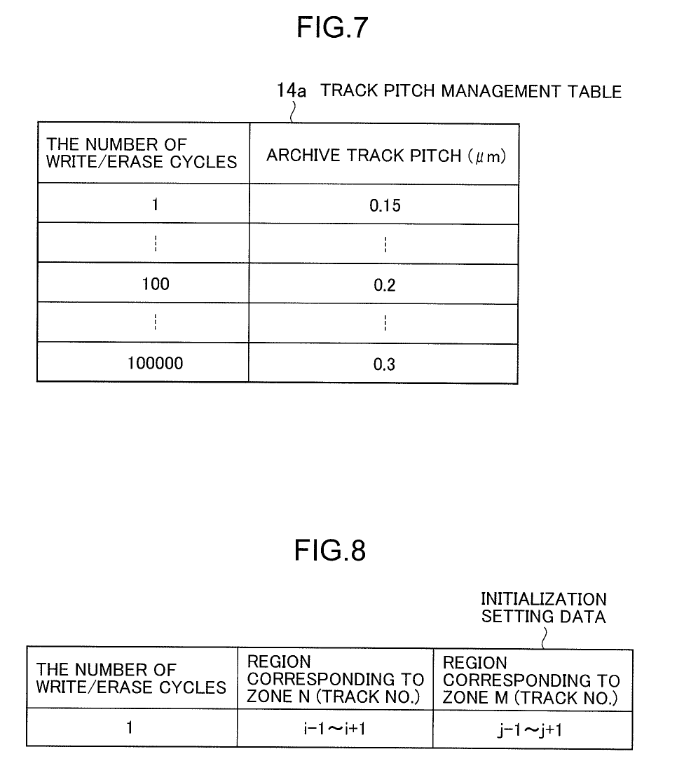

FIG. 6 shows a functional block diagram illustrating a structure of STW 11. As per FIG. 6, STW 11 comprises recording signal generator 12, clock head 13, recording block 14 and control block 15, connected to information recording device 100.

Recording signal generator 12 is controlled by control block 15 and generates signals to record the servo data (hereinafter referred to as servo recording signal) and outputting the signal to clock head 13. Clock head 13 is controlled by control block 15 and records the servo data onto magnetic disk 1 by exposing magnetic disk 1 to the servo recording signal obtained from recording signal generator 12.

Recording block 14 records for recording necessary data and program for various proceedings executed by control block 15. Of the components of recording block 14, track pitch management table 14a shown in FIG. 6 specifically relates to this invention.

Track pitch management table 14a is a table to record a relationship between the write/erase cycles guaranteed and the track pitch. TABLE 7 shows one example indicating a data structure of track pitch management table 14a. As per Table 7, track pitch management table 14a records the write/erase cycles guaranteed, linking it to the archive track pitch (the track pitch of zone M). For example, where the write/erase cycles guaranteed is set to 1, the archive track pitch is set to 0.15. The track pitch management table 14a is made up based on FIG. 4 and FIG. 5 by an administrator, stored in recording block 14 by an input device (not illustrated).

Control block 15 comprises an internal memory to store programs to specify various procedures and control data, thereby executing various processes. Of the components of control block 15, initialization block 15a as shown in FIG. 6 specifically relates to this invention.

Initialization block 15a initializes magnetic disk 1 by controlling recording signal generator 12 and clock head 13. Processes of initialization block 15a will be described specifically below.

Firstly, initialization block 15a obtains initialization setting data from the input device. This initialization setting data includes the write/erase cycles guaranteed and data to specify regions corresponding to zones N and M. Table 8 shows one example illustrating a data structure of the initialization data. In TABLE 8, the write/erase cycles guaranteed is 1, the regions corresponding to zone N are defined with track numbers from i−1 to i+1 and the regions corresponding to zone M are defined with track numbers from j−1 to j+1.

Initialization block 15a compares the initialization setting data with track pitch management table 14a to judge the archive track pitch of zone M when obtaining the initialization data. For instance, where the write/erase cycles guaranteed included in the initialization setting data is 1, initialization block 15a judges the archive track pitch as 0.15 μm (refer to TABLE 7), writing the servo data by controlling recording signal generator 12 and clock head 13 on order to set pitches of the region on magnetic disk 1 corresponding to zone M, i.e., the archive pitch.

Initialization block 15a also writes the servo data by controlling recording signal generator 12 and clock head 13 in order to set pitches of the regions on magnetic disk 1 corresponding to zone N to the regular track pitch. An administrator can preconfigure the regular track pitch and store it in initialization block 15a, or the maximum archive track pitch (i.e., 0.3 μm ) among the archive track pitches included in track pitch management table 14a can be set as the regular track pitch.

After information recording device 100 has been initialized, it will be detached from STW 11 and if needed, assembled with other components before shipping.

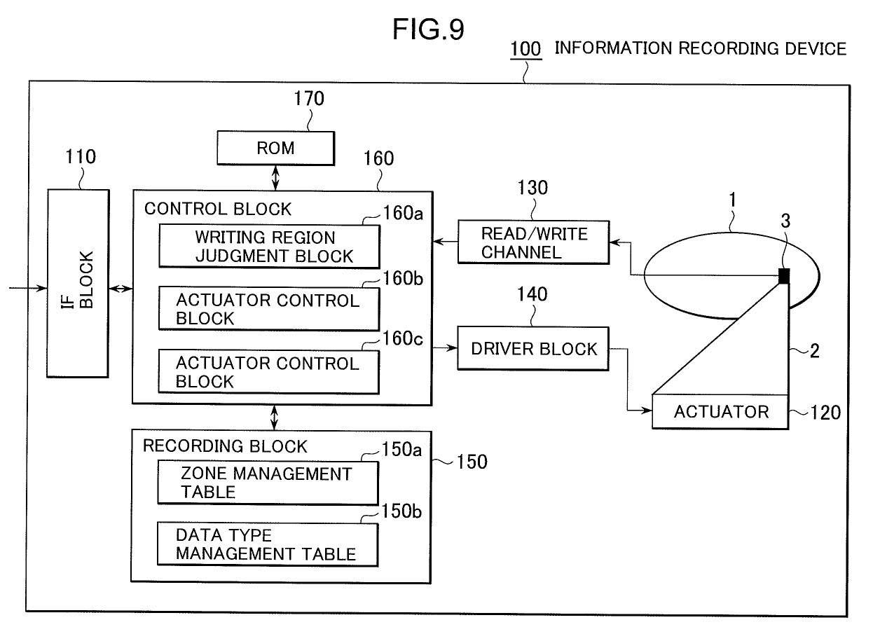

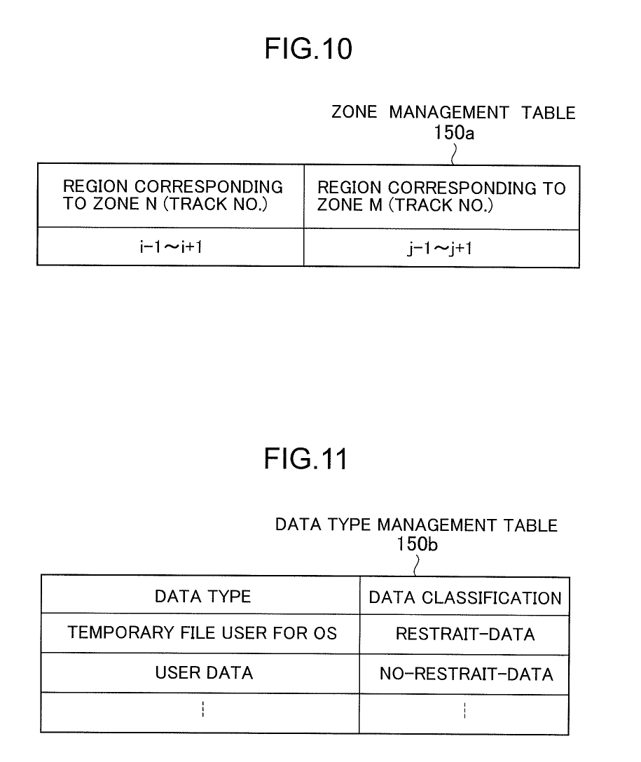

Now a structure of information recording device 100 shown in FIG. 6 will be described. FIG. 9 shows a functional block diagram illustrating a structure of information recording device 100 in this embodiment. As per FIG. 9, this information recording device 100 comprises magnetic desk 1, arm 2, head 3, IF block 110, actuator 120, reading/writing channel 130, driver block 140, recording block 150, control block 160 and ROM 170.

In FIG. 9, magnetic disk 1, arm 2 and head 3 are the same of those shown in FIG. 1 are thus numbered with the same numbers. Repetitive descriptions are not needed. IF block 110 is a device for data communication with a higher-level device (such as a host computer) by using a defined communication protocol.

Actuator 120 comprises a voice call motor (VCM) that drivers head 3 with control current output from driver block 140. Reading/writing channel 130 obtains various data such as the servo data and user data with head 3 and outputs the various data obtained to control block 160. Reading/writing channel 130 also outputs various data (data to be recorded) output from control block 160 to head 3.

Driver block 140 outputs the control current to actuator 120 in response to a control instruction from control block 160, controlling the movement of head 3, and further, outputting the control current to a spindle motor (not illustrated) to control rotation of magnetic disk 1.

Recording block 150 records necessary data for various processes executed by control block 160. Of the components of recording block 150, zone management table 150a and data type management table 150b shown in FIG. 9 specifically relate to this invention.

Zone management table 150a stores data to control zones on magnetic disk 1. Table 10 shows one example indicating a data structure of zone management table 150a. As per Table 10, the zone management table 150a stores the track numbers of the regions corresponding to zones N and M. As described above, no-restraint-data is stored in zone N and restraint-data is stored in zone M.

Data type management table 150b classifies data to be recorded into restraint-data or no-restraint-data. FIG. 11 shows one example illustrating a data structure of data type management table 150b.

As per FIG. 11, data type management table 150b stores data, linking data types to data classifications. Table 11 indicates that the temporary file used for OS is defined as no-restraint-data, while the user data is defined as restraint-data.

Referring to the description of FIG. 9, control block 160 has internal memory to store the program specifying various procedures and control data, thereby executing various processes. Of the components of control block 160, writing region judgment block 160a, access control block 160b, access control block 160b and actuator control block 160c shown in FIG. 9 specifically relate to this invention.

Among them, writing region judgment block 160a judges whether the data to be recorded is classified into no-restraint-data or restraint-data by comparing the data and data type management table 150b where the data is obtained from the higher-level device. Writing judgment block 160a outputs the judgment and the data to be recorded to access control block 160b.

Access control block 160b stores the data to be recorded onto zone N or zone M on magnetic disk 1 based on the judgment delivered by writing region judgment block 160a. Specifically, access control block 160b refers to zone management table 150a where the data to be recorded is classified into no-restraint-data and stores it onto zone N.

Access control block 160b refers to zone management table 150a where the data to be recorded is classified into restraint-data and stores it onto zone M. Where obtaining the data to be recorded from the higher-level device, access control block 160b outputs the obtained data to the higher-level device.

Actuator control block 160c outputs the control instruction to driver block 140, controlling rotation of magnetic disk 1. ROM 170 stores mean for storing necessary data and the programs for various processes executed by control block 160.

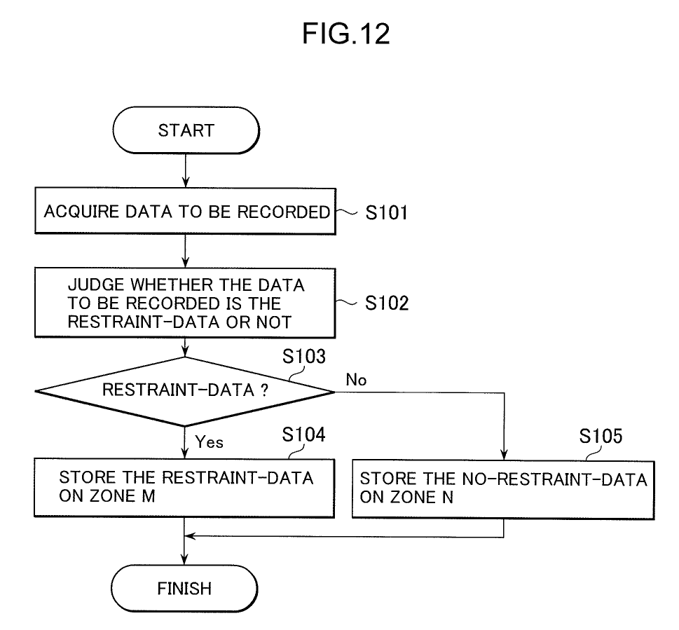

Next, procedures executed by information recording device 100 in this embodiment will be described. FIG. 12 shows a flow chart illustrating procedures executed by information recording device 100. As per FIG. 12, information recording device 100 in this embodiment obtains the data to be recorded from the higher-level device (step S101). Writing region judgment block 160a judges whether the data to be recorded is the restraint-data or the no-restraint-data with reference to data type management table 150b (step S102).

Where the data to be recorded is the restraint-data (step S103, Yes), access control block 160b stores the restraint-data onto the regions corresponding to zone M on magnetic disk 1 (step S104). Where the data to be recorded is the no-restraint-data (step S104, No.), access control block 160b stores the no-restraint-data onto the region corresponding to zone N on magnetic disk 1 (step S105).

As described previously, information recording device 100 in this embodiment loads magnetic disk 1 having regions having different recording densities and stores the data to be recorded onto the different recording regions according to its data type. Thus the storage capacity of the recording medium can be increased without deteriorating the access performance of data stored thereon.

### The Second Embodiment

Next, an information recording system in this embodiment will be described. The information recording system in this embodiment comprises HDDs: the first information recording device has a magnetic disk whose track pitches are the regular track pitch and the second information recording device has a magnetic disk whose track pitches are an archive track pitch. The information recording system stores the data to be recorded in the first information recording device or the second information recording device in accordance with its characteristic (for the descriptions of the regular track pitch and the archive track pitch, refer to the first embodiment).

Thus the information recording system in this embodiment comprises a plurality of the information recording devices having the magnetic disks with different track pitches (different recording densities), selecting any of the information recording devices as data storage according to the characteristic of the data to be recorded. Hence the storage capacity of the entire system can be increased without deteriorating the access performance.

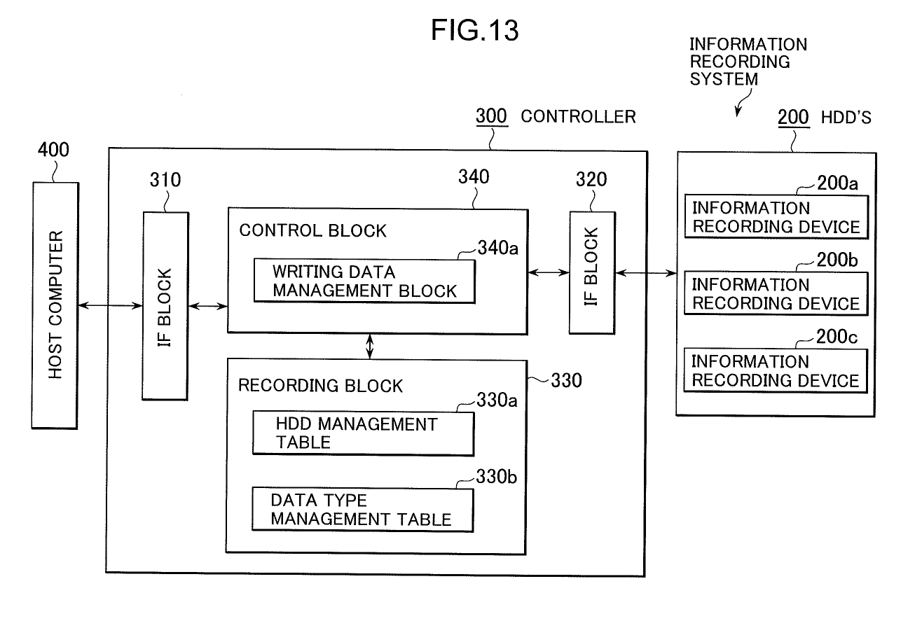

Now a structure of the information recording system in this embodiment will be described. FIG. 13 shows a block chart illustrating a structure of the information recording system in this embodiment. As per FIG. 13, this information recording system comprises HDDs 200, controller 300 and host computer 400. Of the components thereof, host computer 400 is a device for storing a variety of data in HDDs 200 and executing a variety of processes based on the data stored.

HDDs 200 comprises a plurality of information recording devices 200a, 200b and 200c having different recording densities. Host computer 400 recognizes all information recording devices 200a, 200b and 200c as one information recording device. Host computer 400 recognizes a summation of memory capacities of them (regarded as a unity information recording device) as an overall recording capacity.

Information recording devices 200a, 200b and 200c respectively have a magnetic disk having a different recording density. In this embodiment, information recording devices 200a, 200b and 200c are shown exclusively, however, HDDs 200 can comprise other information recording devices.

Information recording device 200a is a device for loading a magnetic disk having a regular track pitch and storing the no-restraint-data with no restraint on the write/erase cycles. Information recording devices 200b and 200c are devices for loading magnetic disks having archive track pitches and storing the restraint-data with restraint on the number write/erase cycles.

Controller 300 controls data input/output between host computer 400 and HDDs 200. In this embodiment, controller 300 allocates data to be recorded to any of information recording devices 200a, 200b and 200c according to the data characteristic when it is obtained from host computer 400.

As per FIG. 13, controller 300 comprises IF blocks 310 and 320, recording block 330 and control block 340. Of the components thereof, IF block 310 is as device for data communication with host computer 400, and IF block 320 is a device for data communication with HDDs 200.

Recording block 330 stores data and programs that are necessary for various processes executed by control block 340. Of the components thereof, HDD management table 330a and data type management table 330b shown in FIG. 12 closely relate with this invention.

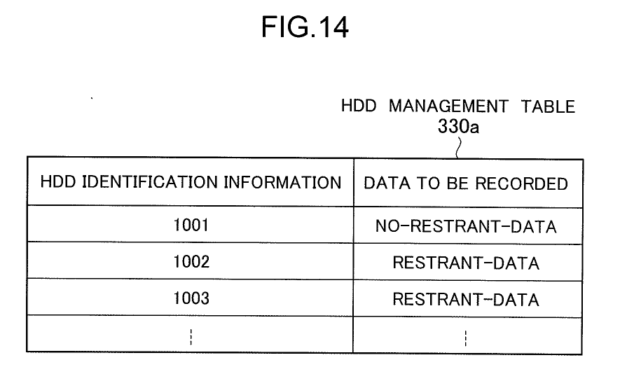

HDD management table 330a is a table for managing the information recording devices. FIG. 14 shows one example illustrating a data structure of HDD management table 330a. As per FIG. 14, HDD management table 330a stores HDD identification information to identify the information recording devices, linking the HDD identification information to data classifications stored in the information recording devices. Here, HDD identification information 1001, 1002 and 1003 correspond to information recording devices 200a, 200b and 200c respectively.

As per FIG. 14, information recording device 200a stores HDD identification information 1001 as the no-restraint-data. Information recording device 200b stores HDD identification information 1002 as the restraint-data. Likewise, Information recording device 200c stores HDD identification information 1003 as the restraint-data.

Data type management table 330b classifies data to be recorded into the restraint-data and the no-restraint-data. Since the data structure of data type management table 330b is the same as data type management table 150b shown in FIG. 11, a description of it will be omitted.

Referring to the description of FIG. 13, control block 340, a control device, has the internal memory to store programs specifying a variety of procedures and the control data, thereby executing a variety of processes. Of the components thereof, writing data management block 340a shown in FIG. 13 closely relates to this invention.

Writing data management block 340a judges whether the data to be recorded is classified into the no-restraint-data or the restraint-data in reference to data type management table 330b when the data is obtained from host computer 400.

Writing data management block 340a refers HDD to management table 330a where the data to be recorded is judged as the no-restraint-data, detecting the information recording device for storing the no-restraint-data (i.e., information recording device 200a), outputting the data to information recording device 200a detected and storing the data therein.

Where the data to be recorded is judged as the restraint-data, writing data management block 340a refers to HDD management table 330a. Then writing data management block 340a detects the information recording device for storing the restraint-data (i.e., information recording device 200b or 200c), outputting the data to the detected information recording device, 200b/200c, and storing the data therein.

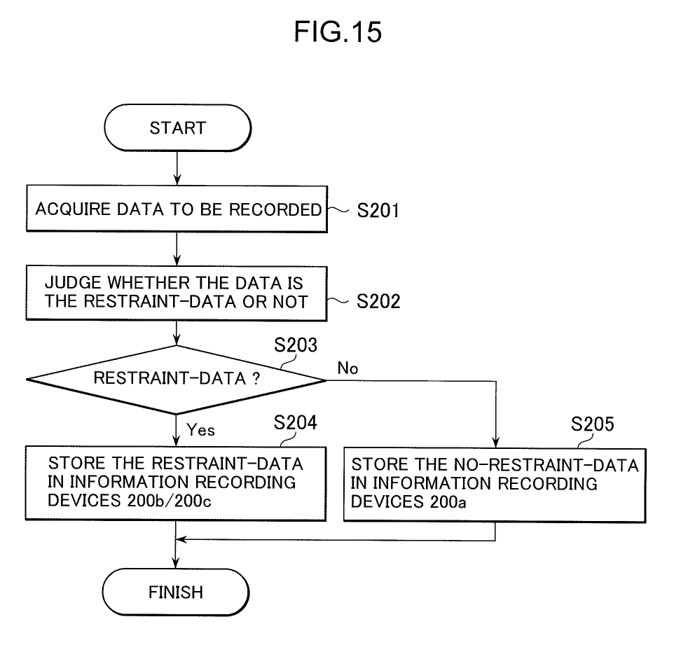

Next, procedures of an information recording system in this embodiment will be described. FIG. 15 shows a flow chart indicating the processes of the information recording system in this embodiment. As per FIG. 15, the information recording system in this embodiment obtains the data to be recorded from host computer 400 (step S201). Writing data management block 340a judges whether the data to be recorded is the restraint-data or the no-restraint-data with reference to data type management table 330b (step S202).

Where the data to be recorded is judged as the restraint-data (step S203, Yes), writing data management block 340a stores the restraint-data in information recording device 200b/200c (step S204). In contrast, where the data to be recorded is judged as the no-restraint-data (step S203, No), writing data management block 340a stores the no-restraint-data in information recording device 200a (step S205).

As described above, the information recording system in this embodiment comprises HDDs 200 having information recording device 200a having the magnetic disk with regular track pitch and information recording device 200b/200c has the magnetic disk with archive track pitch. Once data to be recorded is obtained, the data is stored in information recording devices 200a or 200b/200c in accordance with its characteristic. Thus the storage capacity of the entire system can be increased without deteriorating the access performance.

### The Third Embodiment

Having described the embodiments of this invention, this invention can be achieved in various embodiments other than the first and second embodiments mentioned above. Therefore, another embodiment of this invention will be described below as the third embodiment.

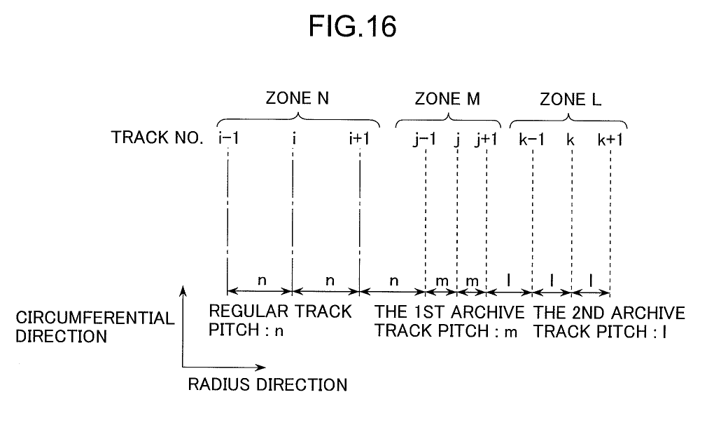

Here, the magnetic disk having different recording densities will be described. In the first embodiment stated above, magnetic disk 1 comprising regions having different densities (zones N and M) are described as an example. However, a plurality of zones that differ from zone N and M in recording density can be set. FIG. 16 shows one example of magnetic disk having zones N, M and L.

In FIG. 16, zone N is defined as track numbers from i−1 to i+1 and its track pitch (the regular track pitch) are defined as n. Zone M is defined as track numbers from j−1 to j+1 and its track pitch (the first archive track pitch) are defined as m. Zone L is defined as track numbers from k−1 to k+1 and its track pitch (the second archive track pitch) are defined as l. Furthermore, the track pitch between zone N and zone M is defined as n, and the track pitch between zone M and zone L is defined as l. They are numbered as i+2=j−1 and j+2=k−1 respectively and their track pitches can be expressed as n>l>m.

That is to say, the relationship between the memory capacities of the zones can be written as zone M>zone L>zone N and the relationship between the write/erase cycles can be written as zone N>zone L>zone M. The relationship between the numbers of their write/erase cycles can be written as zone N>zone L>zone M. The information recording device shown in FIG. 16 has the magnetic disk, for instance, storing the no-restraint-data onto zone N, storing data being edited onto zone L, and storing the restraint-data onto zone M.

The information recording device is a temporary file stored in a memory or onto zone N, referring data to zone M, storing data onto zone L as needed, storing data having been processed onto zone M. Thus the information recording device mainly moves between the tracks in a reading region (zone M) and a read/write region (zone N) adjoining each other in processing, and in order to improve the access performance and the capacity, writing infrequently-accessed data onto zone L.

The hard-to-restrict-write/erase cycles data stored onto zone N is mainly used for access at relatively high speed or for system control of the information recording device itself. Thus the data access is best performed by setting zone N on the outmost circumference of the magnetic disk where the data can be accessed at high speed.

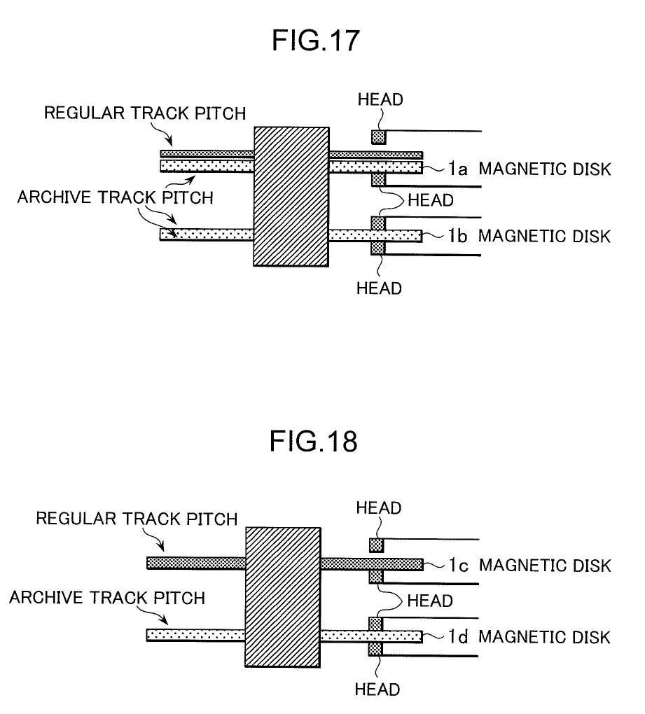

This information recording device does not necessarily have a plurality of regions having different recording densities on one surface of the magnetic disk. On each side of the magnetic disk or on an individual disk, a region having a different recording density can be set. FIG. 17 and FIG. 18 illustrate other setting examples of the zones having different recording densities (the first setting and the second setting).

In the first setting shown in FIG. 17, zone N with the regular track pitch is set on one side of magnetic disk 1a and zone M with the archive track pitch is set on the other side of the disk. On the both sides of magnetic disk 1b, zones M with the archive track pitch are set. In the second setting shown in FIG. 18, zones N with the regular track pitch are set on both sides of magnetic disk 1c. Likewise on both sides of magnetic disk 1d, zones M with the archive track pitch are set.

The various processes described in these embodiments can be achieved by executing prepared programs by a recoding device (a computer). In FIG. 9, various programs to realize the various processes are stored in ROM 170. Various processes to realize features of the various processing blocks (writing region judgment block 160a, access control block 160b and actuator control block 160c) are activated by reading and executing the various programs stored in ROM 170 by control block 160.

The various programs are not necessarily stored in a ROM preliminarily. For example, the various programs can be stored on or in a portable physical medium such as a flexible disk (FD), a CD-ROM, a DVD disk, an optical disk and an IC card, or in other computer (or a sever) connected via public circuit, Internet, LAN or WAN, read and activated by the computer.

So far, various embodiments of this invention has been described, however, this invention can be also realized in various embodiments other than the embodiments in line with the technical ideas described in the scope of claims.

Of the processes described in this embodiment, all or a block of the processes executed automatically can be executed manually. While all or a block of the processes executed manually can be executed automatically with publicly-known methods.

Further, the procedures, control procedures, specific names and the information including a variety of data and the parameters described above or illustrated in the drawings can be changed arbitrarily if not otherwise specified.

Again, each component of each device illustrated is the conceptual features, so they are not necessarily configured as illustrated. Viz, decentralizations/integrations of each device in the specific forms are not limited to those illustrated, and all or a block of them can be configured by functionally and physically decentralizing/integrating by arbitrary unit according to a variety of loads or statuses of use.

In this invention, the information recording device loads a recording medium having a recording density set based on the write/erase cycles. The recording medium comprises the first storage region where the number of data write/erase cycles is restricted and the second storage region where the number of data write/erase cycles is not restricted. Thus the information recording device can change the storage region according to the data characteristics, and thereby stores much more data without deteriorating the access performance. The magnetic disk in widespread use can be used in this invention as a recording medium, thus the manufacturing cost of the information recording device can be curbed.

For all these reasons, the information recording device, the recording device management system and the recording device management method in this invention are useful for recording devices to store a variety of data. Specifically, it is better adapted where a storage capacity of a recording device should be increased without deteriorating an access performance of data stored therein.

What is claimed is:

1. An information recording device for data writing onto a recording medium having a recording density based on a guaranteed number of write/erase cycles, the recording medium comprising:
a first storage region where the number of data write/erase cycles are restricted; and
a second storage region where the number of data write/erase cycles are not restricted.

2. The information recording device according to claim 1 comprising a disk having a plurality of faces thereon,
wherein the disk comprises the first storage region and the second storage region on the same face.

3. The information recording device according to claim 1 comprising a disk having a first face and a second face thereon,
wherein the first face has the first storage region and the second face has the second storage region.

4. The information recording device according to claim 1, wherein the recording medium has a first disk and a second disk,
wherein the first disk has the first storage region and the second disk has the second storage region.

5. A recording device management system for managing a plurality of recording devices having different recording densities respectively, wherein the plural recording devices comprise:
a first recording device having a recording medium with a restraint on the number of data write/erase cycles; and
a second recording device having a recording medium with no restraint on the number of data write/erase cycles, and having a recording management means for recording data selected the first recording device or the second recording device according to a selected characteristic of the data.

6. The recording device management system according to claim 5,
where in for data to be recorded as restraint-data that can be restricted in the number of write/erase cycles, the recording management mean stores the restraint-data in the first recording device, and for the data to be recorded as no-restraint-data that can not be restricted in the number of the write/erase cycles, the no-restraint-data is stored in the second recording device.

7. A recording device management method for managing a plurality of recording devices having at least one recording medium with different recording densities respectively,
characterized in that the plural recording devices comprise a first recording device having a recording medium with a restraint on the number of data write/erase cycles and a second recording device having a recording medium with no restraint on the number of data write/erase cycles,
including an acquisition step for acquiring the data to be recorded; and a recording step for recording the data to be recorded in the first recording device or the second recording device according to the characteristic of the data as determined in data acquisition.

8. The recording device management method according to claim 7,
characterized in that where the data to be recorded is the restraint-data that can restrict the write/erase cycles, the recording step stores the data in the first recording device, and where the data to be recorded is the no-restraint-data that cannot be restricted the write/erase cycles, the data is stored in the second recording device.
